(19) United States
(12) Patent Application Publication
(10) Pub. No.: US 2009/0203555 A1
(43) Pub. Date: Aug. 13, 2009

(54) Use of Relative Permeability Modifiers in Treating Subterranean Formations

(76) Inventors: Arthur Milne, Bogota (CO); Manuel Jose Lastre Buelvas, Bogota (CO)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/028,610

(22) Filed: Feb. 8, 2008

(51) Int. Cl. C09K 8/60

(52) U.S. Cl. 507/222; 507/225

(57) ABSTRACT

A method for treating a subterranean formation penetrated by a wellbore utilizes forming at least one of a treatment fluid A and a treatment fluid B. The treatment fluid A comprises an aqueous carrier fluid, a first relative permeability modifier (RPM) polymer, a water-soluble viscosifying polymer and a crosslinking agent capable of crosslinking the viscosifying polymer at a pH of from about 3 to about 5. The treatment fluid B comprises a fresh-water carrier fluid and a second relative permeability modifier (RPM), and optionally an amount of fibers. At least one of the treatment fluids A and B is introduced into the formation through the wellbore.

### BACKGROUND

The statements in this section merely provide background information related to the present disclosure and may not constitute prior art.

The production of water and aqueous fluids from oil and gas wells is a common phenomenon that may pose a variety of problems. Water production typically acts to reduce the amount of oil and gas that may ultimately be recovered from a well. As the volume of water or aqueous fluids increases, the amount of hydrocarbons that can be produced may be reduced. And as the fields become mature, the amount of water produced tends to increase, sometimes to the point where surface handling systems become overloaded. The increased volume of water may increase the cost and size of the equipment required to separate the water from the produced hydrocarbons. Water production may also cause the formation of emulsions, cause scaling in tubing and equipment, etc. All of this impacts the productivity of well, and thus affects the well's profitability.

The percentage of water produced is defined as the Water Oil Ratio (WOR) for a given well. The water may be what is known as good water, which displaces the crude oil out of the reservoir, or bad water, which is produced without contributing to the production of crude. Bad water is often the result of water invading the reservoir and communicating with the wellbore through permeable channels/fissures etc. Because water usually has a much lower viscosity than the crude oil at reservoir conditions, the effective permeability of the formation to water is much higher than to crude, which tends to result in more water than crude being produced once the water is in direct communication with the wellbore. Bad water production generally increases with time, as the water invades more of the reservoir, and after stimulation treatments. The treatments either selectively stimulates the intervals with water due to the differences in relative permeability, in the case of matrix treatment, while hydraulic fracturing increases the communication of the water bearing zones with the wellbore.

In some cases it may be possible to decrease the production of water using a relative permeability modifier (RPM) to decrease the effective permeability of the reservoir to water without decreasing the effective permeability to crude. An RPM may be a low viscosity polymer that when injected into the matrix a) is highly charged and adheres to the surfaces in the pore spaces; and/or b) reduces the size of the pore throats and thus the relative permeability of the matrix to water, which may occur through a number of different mechanisms, such as swelling in the presence of water. The success of an RPM treatment depends, among other things, on the distance from the formation face that the RPM can be placed. The greater the distance, the longer the effect of the RPM will last. RPMs have been used to treat both stimulated and un-stimulated reservoirs. In the case of stimulated reservoirs, RPMs have been included as part of both matrix and hydraulic fracturing treatments.

Currently there are a number of limitations when attempting to incorporate RPMs into hydraulic fracturing treatments. For example, the naturally low pH of a cationic polyacrylimide RPM makes them incompatible with many conventional neutral and high pH fracturing fluids. An RPM is also known to be more effective when injected in a fluid with a pH between 3 and 5. When the RPM is incorporated into a viscous polymer fracturing fluid the effectiveness of the RPM may be reduced due to the polymer interfering with the adhesion of the RPM to the rock matrix. When RPM is used with solid free fluids, such as viscoelastic surfactant (VES) fluids, there may be potential issues with wettability and compatibility with reservoir fluids. In cases were a low viscosity RPM fluid is injected ahead of the fracturing treatment fluid above fracture pressure, the fracture geometry may be result in high leakoff of the low viscosity RPM fluid into the fracture faces. This leaves a large area of the fracture faces untreated and so limits the effectiveness of the RPM in reducing the production of water. And when the RPM is pumped in only a portion of a fracturing treatment, the distance that the RPM penetrates into the fracture face may be very limited due to the relatively small volume used. This reduces the time for which the treatment is effective, especially in wells with high flow rates. Because of these and other limitations, new methods and improvements for controlling the production of water from subterranean formations in oil and gas wells are needed. The methods in this document will overcome the limitations noted above. The use of these new viscous RPM fluid systems will enable the entire fracture face to be treated when performing a hydraulic fracturing treatment, while at the same minimizing the fluid volume required. It is also possible to realistically model and predict the penetration of these viscous RPM fluids in a hydraulic fracturing treatment using conventional fracturing simulators.

### BRIEF DESCRIPTION OF THE DRAWINGS

For a more complete understanding of the present invention, and the advantages thereof, reference is now made to the following descriptions taken in conjunction with the accompanying figures, in which:

FIG. 1 shows a plot of the viscosities of different aqueous solutions containing different amounts of a relative permeability modifier (RPM) at different temperatures;

FIG. 2 shows a plot of the viscosities of various RPM solutions with and without the use of a guar polymer and quaternary amine salts;

FIG. 3 shows a plot of the permeability of Berea core samples before and after treatment with an RPM solution prepared with fresh water;

FIG. 4 shows a plot of the brine sensitivity of core samples from a formation having a known problem with clay swelling;

FIG. 5 shows a plot of the permeability of the core samples taken from the same formation as that of FIG. 4 before and after treatment with an aqueous treatment fluid containing RPM, guar and a quaternary amine salt;

FIGS. 6 and 7 show plots of the viscosities of different RPM solutions containing different amounts of quaternary amine salts;

FIG. 8 shows a plot of the permeability of a Berea core sample after treatment with the aqueous treatment fluid of FIG. 7;

FIG. 9 shows a plot of the permeability of a Berea core sample before and after treatment with an aqueous treatment fluid containing RPM and 2 wt % KCl;

FIG. 10 shows a plot of the viscosities of linear and crosslinked guar fluids containing RPM;

FIG. 11 shows a plot of the permeability of a Berea core sample before and after treatment with of a crosslinked guar fluid containing RPM and 2 wt % KCl; and

FIG. 12 shows a plot of the permeability of a Berea core sample before and after treatment with a conventional crosslinked guar fluid.

### SUMMARY

A method for treating a subterranean formation penetrated by a wellbore utilizes forming at least one of a treatment fluid A and a treatment fluid B. The treatment fluid A comprises an aqueous carrier fluid, a first relative permeability modifier (RPM) polymer, a water-soluble viscosifying polymer and a crosslinking agent capable of crosslinking the viscosifying polymer at a pH of from about 3 to about 5. The treatment fluid B comprises a fresh-water carrier fluid and a second relative permeability modifier (RPM), and optionally an amount of fibers. At least one of the treatment fluids A and B is introduced into the formation through the wellbore.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating the preferred embodiments of the invention and should not be construed as a limitation to the scope and applicability of the invention. While the compositions of the present invention are described herein as comprising certain materials, it should be understood that the composition could optionally comprise two or more chemically different materials. In addition, the composition can also comprise some components other than the ones already cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

The present invention makes use of relative permeability modifiers (RPMs) in combination with well stimulation treatments, such as fracturing treatments, to inhibit or reduce the production of water from the well. RPM materials used in the present invention are water soluble polymers that are hydrophilic and have the ability to adhere to rock faces of the formation. Thus, the polymers may be absorbed onto the rock faces and surfaces and, when contacted with water, swell so that the pores and interstices of the formation are filled or plugged by the polymer to prevent the passage of water through the pore channels and fissures.

The RPM polymers are polymers, oftentimes hydrophilic polymers, that are typically polyacrylamides, hydrolyzed polyacrylamide, xanthan, scleroglucan, polysaccharides, amphoteric polymers made from acrylamide, acrylic acid, and diallyldimethylammonium chloride, vinyl sulfonate/vinyl amide/acrylamide terpolymers, vinyl sulfonate/acrylamide copolymers, acrylamide/acrylamido-methylpropanesulfonic acid copolymers, acrylamide/vinylpyrrolidone copolymers, sodium carboxymethyl cellulose and poly[dialkylaminoacrylate-co-acrylate-g-poly(ethyleneoxide)]. Of these, poly[dialkyl-aminoacrylate-co-acrylate-g-poly(ethyleneoxide)] and polyacrylamides are preferred. These may include homopolymers and copolymers of acrylamide, including block or random copolymers of acrylamide and one or more other monomers. As used herein, unless as expressly stated or as is apparent from its context, the expression “polymer,” “polyacrylamide,” etc., is meant to encompass both homopolymers and copolymers. The polyacrylamide may have an average molecular weight of from at least about 100,000 to about or 10,000,000 or more.

The acrylamide units of the polyacrylamide polymer may be substituted with cationic functional groups. In some cases, the cationic functional groups may include sulfonate groups. The cationic substitution may facilitate adherence of the polyacrylamide to the rock surface, which is typically negatively charged. An example of a suitable cationic polyacrylamide polymer is ethanaminium, N,N,N-trimethyl-2-[(1-oxo-2 propenyl)oxy]-, chloride, polymer with 2-propenamide).

In certain applications, the RPM is non-hydrophobic or contains a nominal amount, if any, hydrophobic groups, such as alkyl groups, incorporated with the polymer, to provide hydrophobic properties to the polymer.

The RPM may be used in different amounts. In typical treating fluids the RPM may be used in an amount of from about 0.01% to about 1% or more by weight of the treating fluid. More typically, the RPM is used in an amount of from about 0.1% to about 0.5% by weight of the treating fluid, and in particular, the RPM may be used in an amount of from about 0.1% to about 0.3% by weight of the treating fluid. In the case of the fiber-based fluids, as are described herein, the amount of RPM used may be from about 0.1 to about 0.5% by weight of the treating fluid.

In some embodiments, the RPM is used in conjunction with a water-soluble viscosifying polymer that is capable of being crosslinked with transition metal crosslinking agents. The most commonly used examples being titanium and zirconium complexes because of their affinity for reacting with oxygen functionalities (cis-OH and carboxyl groups), stable +4 oxidation states and low toxicity. These crosslinking agents will crosslink polymers at a low pH of from about 3 to about 5 and a high pH of about 7 to about 11. Aluminum (III) crosslinking agents may also be used for crosslinking polymers at a pH of about 3 to about 5. The water-soluble viscosifying polymers are familiar to those in the skilled in the art and may include, but are not limited to, guar, galactomannan gums, glucomannan gums, derived guars and cellulose derivatives. High-molecular weight polysaccharides composed of mannose and galactose sugars may be used. Nonlimiting examples of suitable water-soluble viscosifying polymers include guar gum, locust bean gum, karaya gum, high-molecular weight polysaccharides composed of mannose and galactose sugars, or guar derivatives such as hydropropyl guar (HPG), carboxymethyl guar (CMG), and carboxymethylhydroxypropyl guar (CMHPG). Cellulose derivatives such as hydroxyethylcellulose (HEC) or hydroxypropylcellulose (HPC) and carboxymethylhydroxyethylcellulose (CMHEC) may also be used. Any useful polymer may be used in either crosslinked form, or without crosslinker in linear form. Xanthan, diutan, and scleroglucan, three biopolymers, have been shown to be useful as viscosifying agents. Synthetic polymers such as, but not limited to, polyacrylamide and polyacrylate polymers and copolymers are used typically for high-temperature applications.

In some embodiments, the viscosifier is a water-dispersible, linear, nonionic, hydroxyalkyl galactomannan polymer or a substituted hydroxyalkyl galactomannan polymer. Examples of useful hydroxyalkyl galactomannan polymers include, but are not limited to, hydroxy-C₁-C₄-alkyl galactomannans, such as hydroxy-C₁-C₄-alkyl guars. Preferred examples of such hydroxyalkyl guars include hydroxyethyl guar (HE guar), hydroxypropyl guar (HP guar), and hydroxybutyl guar (HB guar), and mixed C₂-C₄, C₂/C₃, C₃/C₄, or C₂/C₄ hydroxyalkyl guars. Hydroxymethyl groups can also be present in any of these.

As used herein, substituted hydroxyalkyl galactomannan polymers are obtainable as substituted derivatives of the hydroxy-C₁-C₄-alkyl galactomannans, which include: 1) hydrophobically-modified hydroxyalkyl galactomannans, e.g., C₁-C₁₈-alkyl-substituted hydroxyalkyl galactomannans, e.g., wherein the amount of alkyl substituent groups is preferably about 2% by weight or less of the hydroxyalkyl galactomannan; and 2) poly(oxyalkylene)-grafted galactomannans (see, e.g., A. Bahamdan & W. H. Daly, in Proc. 8PthP Polymers for Adv. Technol. Int'l Symp. (Budapest, Hungary, September 2005) (PEG- and/or PPG-grafting is illustrated, although applied therein to carboxymethyl guar, rather than directly to a galactomannan)). Poly(oxyalkylene)-grafts thereof can comprise two or more than two oxyalkylene residues; and the oxyalkylene residues can be C₁-C₄ oxyalkylenes. Mixed-substitution polymers comprising alkyl substituent groups and poly(oxyalkylene) substituent groups on the hydroxyalkyl galactomannan are also useful herein. In various embodiments of substituted hydroxyalkyl galactomannans, the ratio of alkyl and/or poly(oxyalkylene) substituent groups to mannosyl backbone residues can be about 1:25 or less, i.e. with at least one substituent per hydroxyalkyl galactomannan molecule; the ratio can be: at least or about 1:2000, 1:500, 1:100, or 1:50; or up to or about 1:50, 1:40, 1:35, or 1:30. Combinations of galactomannan polymers according to the present disclosure can also be used.

As used herein, galactomannans comprise a polymannose backbone attached to galactose branches that are present at an average ratio of from 1:1 to 1:5 galactose branches:mannose residues. Preferred galactomannans comprise a 1→4-linked β-D-mannopyranose backbone that is 1→6-linked to α-D-galactopyranose branches. Galactose branches can comprise from 1 to about 5 galactosyl residues; in various embodiments, the average branch length can be from 1 to 2, or from 1 to about 1.5 residues. Preferred branches are monogalactosyl branches. In various embodiments, the ratio of galactose branches to backbone mannose residues can be, approximately, from 1:1 to 1:3, from 1:1.5 to 1:2.5, or from 1:1.5 to 1:2, on average. In various embodiments, the galactomannan can have a linear polymannose backbone. The galactomannan can be natural or synthetic. Natural galactomannans useful herein include plant and microbial (e.g., fungal) galactomannans, among which plant galactomannans are preferred. In various embodiments, legume seed galactomannans can be used, examples of which include, but are not limited to: tara gum (e.g., from Cesalpinia spinosa seeds) and guar gum (e.g., from Cyamopsis tetragonoloba seeds). In addition, although embodiments of the present invention may be described or exemplified with reference to guar, such as by reference to hydroxy-C₁-C₄-alkyl guars, such descriptions apply equally to other galactomannans, as well.

The water-soluble polymer may be present at any suitable concentration. In various embodiments hereof, the gelling agent can be present in an amount of from about 0.1 wt. % to about 1.5 wt. % of total weight of treating fluid, from about 0.1 wt. % to about 0.7 wt. % of total weight of treating fluid, from about 0.1 wt. % to about 0.6 wt. % of total weight of treating fluid, from about 0.1 wt. % to about 0.5 wt. % of total weight of treating fluid, from about 0.1 wt. % to about 0.4 wt. % total weight of treating fluid, from about 0.1 wt. % to about 0.3 wt. % of total weight of treating fluid, or even from about 0.1 wt. % to about 0.2 wt. % of total weight of treating fluids. Preferably, the water-soluble polymer may be present in an amount of from about 0.1 wt. % to about 0.5 wt. % of total weight of treating fluid, with a lower limit of polymer being no less than about 0.1, 0.2, 0.3, or 0.4 wt. % of total weight of treating fluid. Fluids incorporating the polymer may have any suitable viscosity, preferably a viscosity value of about 50 mPa-s or greater at a shear rate of about 100 s-1 at treatment temperature, more preferably about 75 mPa-s or greater at a shear rate of about 100 s-1, and even more preferably about 100 mPa-s or greater. The polymer may be mixed with an aqueous fluid such as water or brine containing 1-2 wt. % KCl.

Although the RPM may be used in combination with the water-soluble viscosifying polymers in their linear or non-crosslinked form, they may also be crosslinked to provide further viscosity enhancement. The crosslinking agent used with the hydratable polymers may be a heavy metal compound crosslinking agent. The heavy metal compounds may include Zr, Ti, Cr or Hf organo-metallic compounds. In particular, organo-zirconium and titanium crosslinking agents are useful. Examples of suitable zirconium crosslinking agents include zirconium triethanolamine, zirconium diethanolamine, zirconium tripropanolamine, and zirconium lactate complexes, and/or the related salts, and/or their mixtures. Examples of titanium crosslinking agents include titanium triethanolamine and titanium acetylacetonate. Aluminum (III) crosslinking agents may also be used. Boron, which is also used often to crosslink polymers like guar, etc., is not used in the present application because it requires a higher pH (i.e. pH>5) to be effective.

The crosslinking agent may be used in an amount of typically less than about 0.15 wt %, more particularly less than about 0.1 wt % of treating fluid, and still more particularly less than about 0.07 wt % of treating fluid. An example of a suitable range for the crosslinking agent for many applications is from about 0.01 wt % to about 0.1 wt %.

In conventional fluids, the pH of the treating fluid containing the crosslinkable polymers must be lowered from a pH of 7 or higher to a pH of less than 5 by the use of an acid, such as glacial acetic acid, before being crosslinked with a transition metal crosslinking agent. In the present invention, however, the use of such an acid or pH adjusting agent is not necessary because the addition of an RPM (e.g. polyacrylamide) to a conventional fluid will lower the pH of the fluid to about 5 or less, more commonly to a pH of from about 3 to about 4, thus facilitating the crosslinking of the hydratable viscosifying polymers. When used in the treating fluid, the RPM effectively lowers the pH of the fluid from about 4 to about 5 to thus facilitate crosslinking of the hydratable polymers. This is irrespective of the amount of RPM used. Thus, once the pH of the fluid has been lowered by the addition of a low concentration of RPM, the addition of more RPM will not lower the pH of the fluid further, as would an acid. Hence a conventional fluid system containing an RPM is effectively buffered in the pH range of about 3 to about 5.

If desired or in case the particular RPM does not provide the required pH, however, an acid or additional pH adjusting agent may be used with the crosslinked polymer fluids. The acidic pH adjusting agent may be a carboxylic acid. Examples of suitable carboxylic acids may include acetic acid (HAc), formic acid, propionic acid and glycolic acid. Inorganic acids, such as hydrochloric acid (HCl) and sulfuric acid (H₂SO₄), may also be used as the acidic pH adjusting agents to provide a desired pH.

The aqueous medium used in the treating fluid wherein crosslinkable polymers are used may be a brine of a monovalent salts, such as KCl and NH₄Cl, 1-5 wt. % KCl, for example. As will be discussed later on, this is distinguished from the treatment fluids incorporating hydrated RPM, with or without fibers, to provide the transporting characteristics, which require the use of fresh water. The presence of monovalent salts suppresses the hydration of the RPM in the solution so that they may only be partially hydrated. In this case the viscosity of the RPM in solution will typically be less than about 30 mPa·s and more typically be less than about 20 mPa·s when measured in a FANN 35 R1/B1 @170 sec⁻¹. Other salts or electrolytes that suppress the hydration of the RPM resulting in similar viscosities may also be used. In this way, when the crosslinked polymer/RPM solution is injected into the formation, the filtrate or interstitial water containing the partially hydrated RPM will leak off into the pores and fracture faces, where it adheres thereto, to facilitate inhibition of water production. As water is produced from the formation to dilute or wash away the electrolytes (salts), the RPM will regain its hydrophilic properties and will swell to block the pores or interstitial areas of the matrix.

In those embodiments of the invention where the aqueous medium is brine, the brine may include an inorganic salt or organic salt. Examples of suitable inorganic salts include alkali metal halides, for example, sodium chloride (NaCl), potassium chloride (KCl). Sodium bromide (NaBr), potassium bromide (KBr), or cesium bromide (CsBr) may also be used. Any mixtures of the inorganic salts may be used as well, an example being seawater. The salt may be chosen for compatibility reasons, for example, where the reservoir drilling composition used a particular brine phase and the completion/clean up composition brine phase is chosen to have the same brine phase. The carrier brine phase may also comprise an organic salt, such as tetramethyl ammonium chloride. The salt or electrolyte may be used in an amount of from about 0.01 wt % to about 15 wt % of the treating fluid, and more particularly from about 1 wt % to about 8 wt % of the treating fluid, and still more particularly from about 1 wt % to about 5 wt % of the treating fluid.

The inorganic salt or salt mixture or a component thereof may assist in maintaining the stability of a geologic formation to which the fluid is exposed. Formation stability, and in particular clay stability (by preventing the migration or swelling of clay particles in reaction to water-base fluid, for example), is achieved at a concentration level of a few percent by weight and as such the density of fluid is not significantly altered by the presence of the inorganic salt. In many applications a suitable electrolyte for formation stability may include potassium chloride, ammonium bifluoride and sodium chloride.

In certain applications, a crosslinking delay agent may be used to delay the crosslinking of the polymer. Any readily known delay agent may be used. The delaying agent may be used in an amount of from about 0.01 wt. % to about 0.5 wt. % of treating fluid, more particularly, from about 0.05 wt. % to about 0.25 wt. %.

The RPM/polymer solutions are particularly useful as carrier fluids for proppants. The typical proppant size distribution is about 0.42-0.84 mm (˜40 mesh to 20 mesh). The proppants may be those that are substantially insoluble in the polymer solution and/or fluids of the formation. Proppant particles carried by the treatment composition remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particalization, processing, etc.

The concentration of proppant in the composition may be any concentration that is suitable for carrying out the particular treatment desired and that may be suspended within the treatment fluid without settling. For example, the proppant may be used in an amount up to about 1.5 kilograms of proppant added per liter of the composition. Also, any of the proppant particles may be coated with a resin to potentially improve the strength, clustering ability, and flow back properties of the proppant.

The RPM/polymer fluid may provide a treatment fluid with a viscosity of from about 30 mPa·s to about 1000 mPa·s at 100 sec⁻¹. The RPM/polymer treatment fluid may be suitable for treating formations at temperatures of up to about 300° F. (150° C.).

The compositions may also include a breaker. The purpose of this component is to “break” or diminish the viscosity of the fluid so that this polymer fluid is more easily recovered from the propped fracture during cleanup. With regard to breaking down viscosity, oxidizers, enzymes, or acids may be used. Breakers reduce the polymer's molecular weight by the action of an acid, an oxidizer, an enzyme, or some combination of these on the polymer itself. After cleanup, the RPM will remain adhered to the rock surfaces and thus remain in the formation to facilitate prevention of water production. The use of non-delayed conventional breakers, such as oxidizers, may only be used in low concentrations because they may diminish the performance of the RPM due the degradation of the polymer. An encapsulated breaker may also be used with the low concentration of non-delayed breaker or may be used by itself to minimize any possible interaction of the breaker with the RPM polymer. U.S. Pat. No. 5,103,905, which is herein incorporated by reference, describes such breakers. After cleanup, the RPM that has leaked off into the formation matrix will remain adhered to the surfaces of the pore spaces in the formation matrix and thus cause a disproportionate permeability reduction (DPR) with respect to water, which reduces the water production.

In another application, the RPM is used without the water-soluble viscosifying polymers but is used alone in hydrated form or in combination with an amount of fibers to facilitate proppant transport. The same proppants as those described previously can be used and in similar amounts. The fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) fibers available from Invista Corp., Wichita, Kans., USA, 67220. Other examples of useful fibers include, but are not limited to, polylactic acid polyester fibers, polyglycolic acid polyester fibers, polyvinyl alcohol fibers, and the like. The fibers may be degradable or non-degradable. The RPM may be used in combination with the fiber transport systems described in U.S. Pat. No. 7,275,596, which is herein incorporated by reference in its entirety, with or without an additional viscosifier, as is described later on.

When used with the RPM, the fiber component may be included in the treatment fluid at concentrations of from about 0.01% to about 1% or more by weight of the treatment fluid, more particularly the concentration of fibers may be from about 0.1% to about 0.6% by weight of the treatment fluid, and more particularly from about 0.1% to about 0.4% by weight of the fluid.

When the RPM is used in combination with fibers to form a treatment fluid, the carrier fluid may be a fresh-water carrier fluid. As used herein, “fresh water” or variances of this expression are meant to encompass aqueous fluids with less than about 0.001% by weight of the aqueous fluid of any salt or electrolyte that may inhibit or interfere with the hydrophilic characteristics of the RPM. Fresh water is used in this embodiment because the RPM is hydrated to facilitate viscosification of the treatment fluid, whereas the KCl or other salts used in combination with the treatment fluids, such as those employing the water soluble crosslinkable polymers, described previously, inhibit the hydration of the RPM.

A quaternary amine salt may be combined with the RPM/fiber treatment solution. The quaternary amine salt facilitates the stabilization of clays and the formation matrix. Unlike potassium chloride and similar salts, which are typically used in treatment fluids for stabilization of clays, the quaternary amine salts do not interfere with hydration of the RPM and do not lower the fluid viscosity of the RPM solution. The quaternary amine salts, however, facilitate the stabilization of clays and formation materials when introduced into the formation. The quaternary amine salts are cationic so they are compatible with the cationic-substituted RPM materials.

The quaternary amine salts used in the present invention may include those described in U.S. Pat. No. 7,287,593, which is hereby incorporated by reference in its entirety. Examples of such quaternary amine salts include, but are not limited to, di-(hydrogenated tallowalkyl) dimethyl ammonium chloride, cocoalkyltrimethyl ammonium chloride, benzyldimethylcocoalkyl ammonium chloride, benzylbis(2-hydroxyethyl)cocoalkyl ammonium chloride, alkyl (C12-16) dimethyl benzyl ammonium chloride, and coco benzyl ammonium chloride ethoxylate. A particular useful quaternary amine salt is cocobis(2-hydroxyethyl)methyl ammonium chloride.

The quaternary amine salt may be added to the treatment fluid in any amount effective to facilitate stabilization of formation clays. The amine salt may be added in the amount from about 0.1% to about 10% by weight of the treatment fluid, more particularly, from about 0.1% to about 5% by weight of the treatment fluid, and still more particularly, from about 0.1% to about 3% by weight of the treatment fluid. The amine salt may be added in any effective form including a liquid form, a solid form, or a solution such as an aqueous salt solution.

In another application, the RPM may be used in combination with both crosslinkable, water-soluble polymers and fibers. In such an application, the water-soluble polymers are those, such as described previously, that are crosslinkable at low pH of from about 3 to about 5, and the fibers may be the same as those previously described. The amount of water-soluble polymer and fiber may be balanced to provide the desired proppant transport properties. Smaller amounts of the polymer and fiber may be used in combination than when each is used separately without the other. Other components, such as crosslinking agents, etc. may be used in similar amounts or in amounts corresponding to the amounts needed to achieve the desired final fluid properties.

When the RPM is used with both the water-soluble polymers and fibers, the RPM can be used in both hydrated or unhydrated form. Because the water-soluble polymers, linear or crosslinked, provide increased viscosity to the fluid, the carrier fluid may be an aqueous brine or may contain salts that suppress the hydration of the RPM. Alternatively, the carrier fluid may be fresh water so that the RPM is hydrated. In such cases, a quaternary amine salt may be used to provide clay or matrix stabilization effects.

The treatment fluids of the invention, employing RPM in combination with both crosslinkable, water-soluble polymers and fibers or both, may further contain other additives and chemicals that are known to be commonly used in oilfield applications by those skilled in the art. These include, but are not necessarily limited to, materials such as surfactants, high temperature fluid stabilizers (e.g. sodium thiosulfate), oxygen scavengers, alcohols (e.g. isopropanol), scale inhibitors, corrosion inhibitors, fluid-loss additives, bactericides, and the like. Surfactants or surface active agents may be added to the fluid to facilitate clean up of fracturing fluid after treatment. Also, surfactants may be included to optimize viscosity or to minimize the formation of stable emulsions that contain components of crude oil or other polymers. In the case of high bottomhole static temperature (>95° C.), additional high temperature stabilizers may be added to prevent oxidation or radical reaction.

Compositions according to the invention may be foamed and energized well treatment fluids that contain “foamers,” which may include surfactants or blends of surfactants that facilitate the dispersion of a gas into the composition to form of small bubbles or droplets, and confer stability to the dispersion by retarding the coalescence or recombination of such bubbles or droplets. Foamed and energized fluids are generally described by their foam quality, i.e. the ratio of gas volume to the foam volume. If the foam quality is between 52% and 95%, the fluid is conventionally called a foamed fluid, and below 52%, an energized fluid. Hence, compositions of the invention may include ingredients that form foams or energized fluids, such as, but not necessarily limited to, foaming surfactant, or blends of surfactants, and a gas which effectively forms a foam or energized fluid. Suitable examples of such gases include carbon dioxide, nitrogen, or any mixture thereof.

In fracturing treatments, the compositions of the present invention may be used in the fluids used to perform a minifrac, step rate or calibration test, in pre-pad and pad treatments without proppant, the proppant stage, or in all stages of the treatment. The components are mixed on the surface and then introduced into the formation through a wellbore. In hydraulic fracturing treatments, the fluids may be introduced above the fracture pressure of the formation.

The following examples further serve to illustrate the invention.

### EXAMPLES

### Example 1

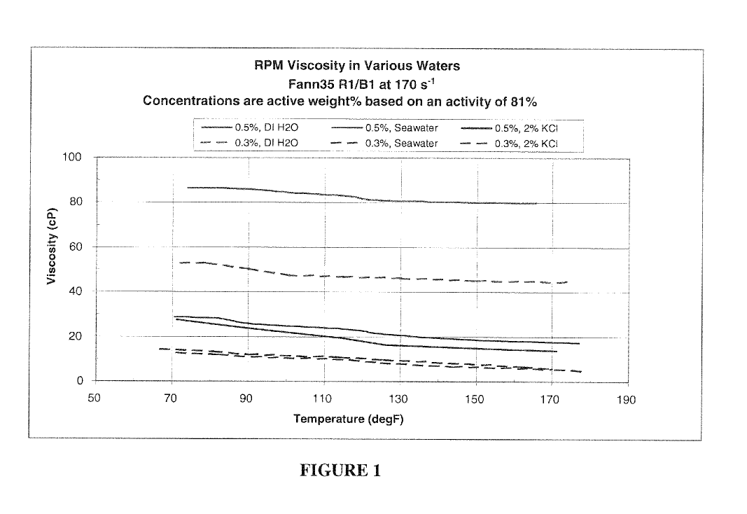

Various concentrations of RPM were prepared in deionized water, sea water and an aqueous 2 wt. % KCl brine to determine the viscosity of the RPM solutions. The RPM used was ethanaminium, N,N,N-trimethyl-2-[(1-oxo-2 propenyl)oxy]-, chloride, polymer with 2-propenamide) at an 81% active concentration (hereinafter “RPM-A”). The viscosities were measured using a Fann 35 R1/B1 viscometer at 170 sec⁻¹. The results are presented in FIG. 1.

### Example 2

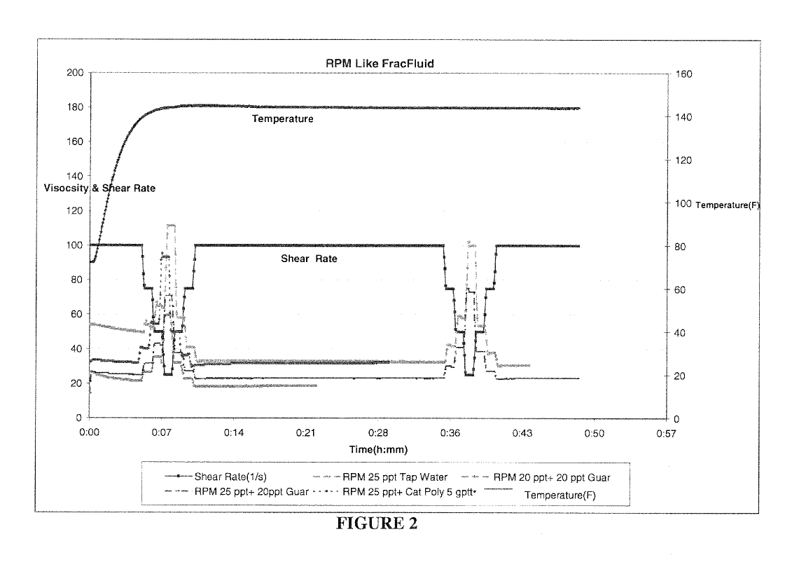

Various linear (non-crosslinked) fluids were prepared with RPM-A at varying concentrations in fresh tap water with and without the addition of guar polymer (hereinafter “Guar A”) and a cationic quaternary amine salt (hereinafter “Amine Salt A”). The viscosities were measured using a Chandler 5550 Rheometer R1/B1. The results are presented in FIG. 2. As can be seen, the addition of the amine salt did not adversely affect the rheology of the fluid.

### Example 3

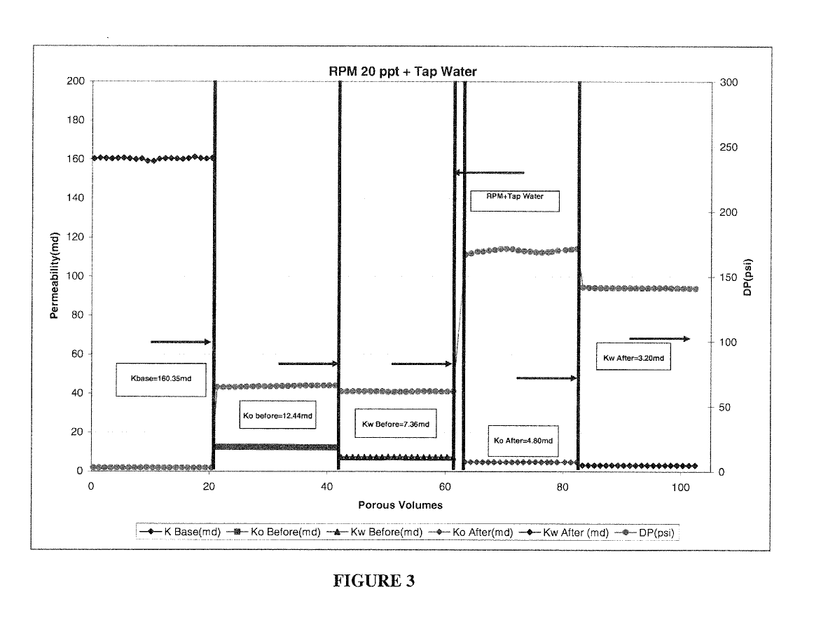

Static leakoff tests were conducted on 1.5-inch (3.8 cm) diameter Berea core plug samples using a 0.24% by weight (20 ppt) of RPM-A in fresh water. The cores were held in a Hassler type core holder. The fluids were pumped at constant flow rates through the cores using an ISCO 2350 HPLC pump. Low range and high range Rosemount differential pressure transducers were used to measure the pressure drop across the core. The fluids were injected into the cores for 30 minutes with a 500 psi (3447 kPa) pressure differential. The results are presented in FIG. 3 and in Table 1 below. The test shows that the reduction in permeability to water is 55% and the reduction in permeability to oil is 61%. The reduction in permeability to water and oil is about equal and may be due to either polymer damage or clay swelling.

TABLE 1

| | Before | After |
|---|---|---|
| Swr | 20% | 49% |
| Kro a Swr | 0.10 | 0.10 |
| Sor | 44% | 39% |
| Krw a Sor | 0.35 | 0.27 |

### Example 4

Tests were conducted on a 1.5-inch (3.8 cm) core samples from a formation in which 10 to 15% by volume of the formation matrix is composed of Koalinite/smectite. These two clay minerals are known to swell and/or migrate in the presence of fresh water, which destabilizes the structure of the clays, resulting in a substantial reduction in the permeability of the matrix. The core samples were tested to determine their sensitivity to various KCl brine concentrations using the following procedures:
1. Record core dimensions.
2. Vacuum saturate core in test brine (7% KCl).
3. Load the core into the core flow apparatus and apply the overburden (2,000 psi).
4. Heat the cell to operating temperature (100° F.) and apply backpressure −500 psi.
5. Measure initial, stable permeability with 7% KCl at 5 ml/min in production direction.
6. Measure permeability with 5% KCl at 5 ml/min in production.
7. Measure final, stable permeability with 7% NH₄Cl at 5 ml/min production direction.
8. Repeat steps 5 to 7 with 4%, 3% and 2% KCl.
9. Inspect core for any visual signs for damage and deconsolidation.

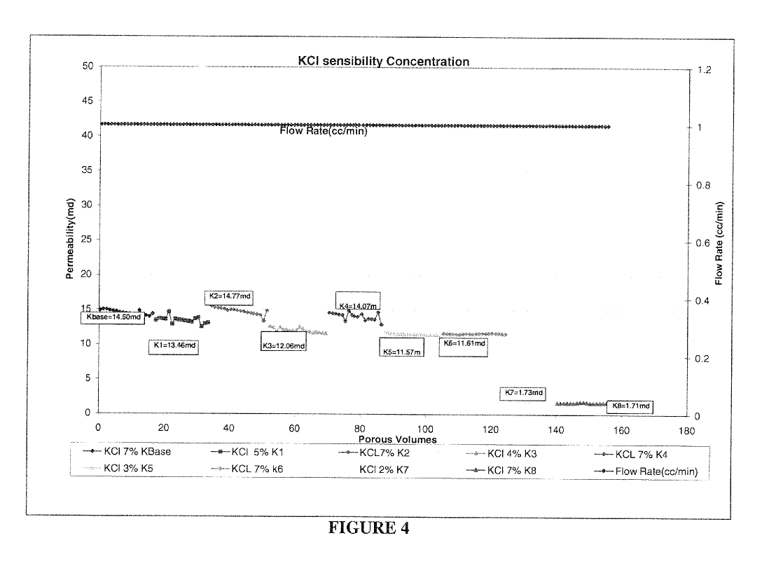

The results from the brine sensitivity tests for the core samples are presented in FIG. 4.

### Example 5

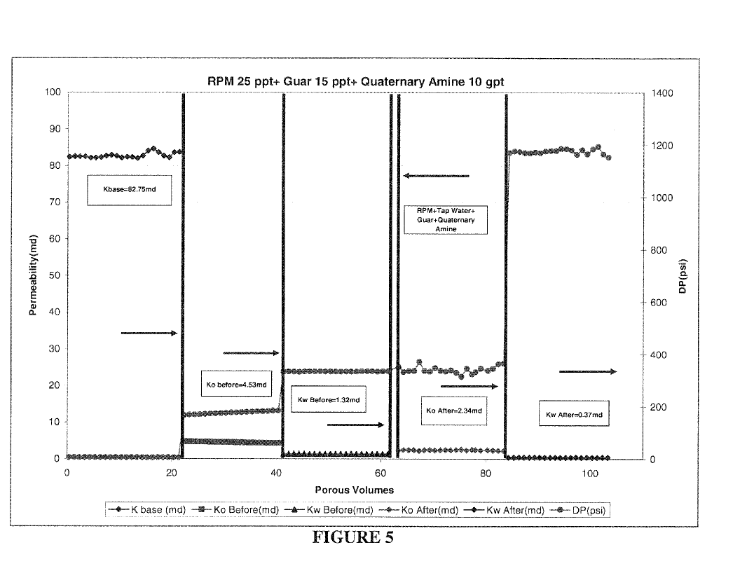

Static leak off tests were conducted on the core samples from Example 4 using the same procedures described for Example 3. A linear treatment fluid was prepared using fresh water and 0.3% by weight of treating fluid (25 ppt) of RPM-A, 0.18% by weight of treating fluid (15 ppt) Guar A and 1.5% by weight (15 gpt) Amine Salt A. The results are presented in FIG. 5 and Table 2 below. As can be seen, the reduction in permeability of the core sample to water after treatment was 71%, while the reduction in permeability to oil was 48%.

TABLE 2

| | Before | After |
|---|---|---|
| Swr | 25% | 32% |
| Kro a Swr | 0.12 | 0.08 |
| Sor | 42% | 39% |
| Krw a Sor | 0.59 | 0.49 |

### Example 6

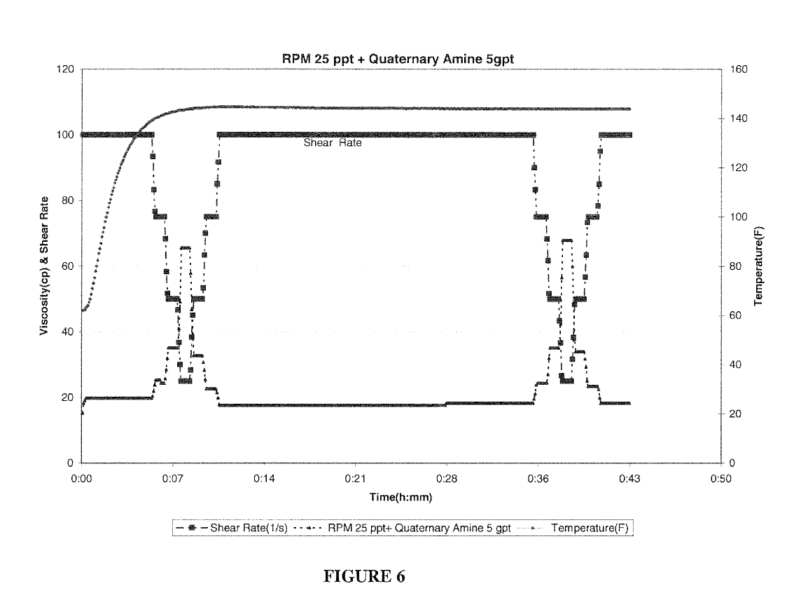

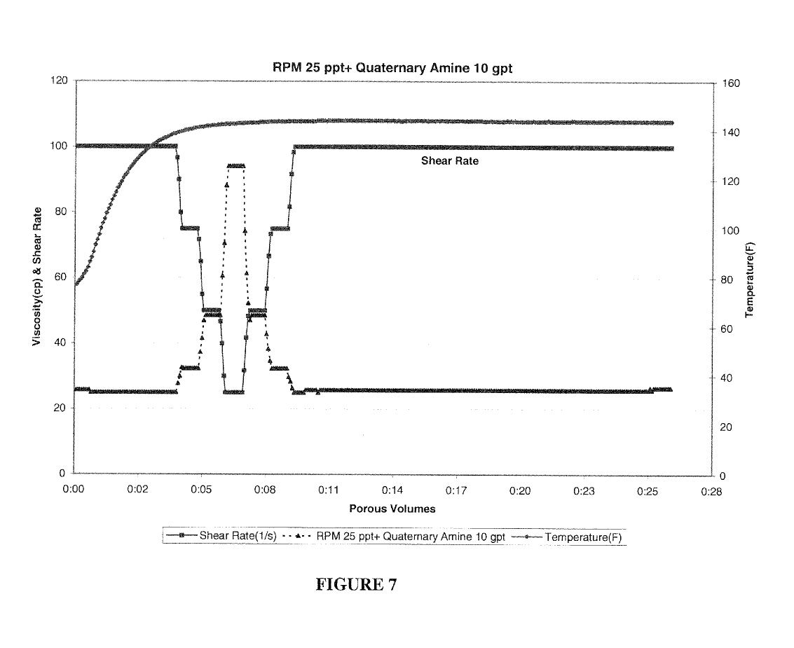

Tests were conducted on RPM fluids to determine the effect of the quaternary amine salt at different concentrations. Treatment fluids using fresh tap water containing 0.3% by weight of treating fluid (25 ppt) RPM-A and 0.5% by weight of treating fluid (5 ppt) (Sample 1) and 1% by weight of treating fluid (10 ppt) (Sample 2) of Amine Salt A, respectively, were prepared. The viscosities were measured using a Chandler 5550 Rheometer R1/B1. The results are presented in FIGS. 6 and 7.

### Example 7

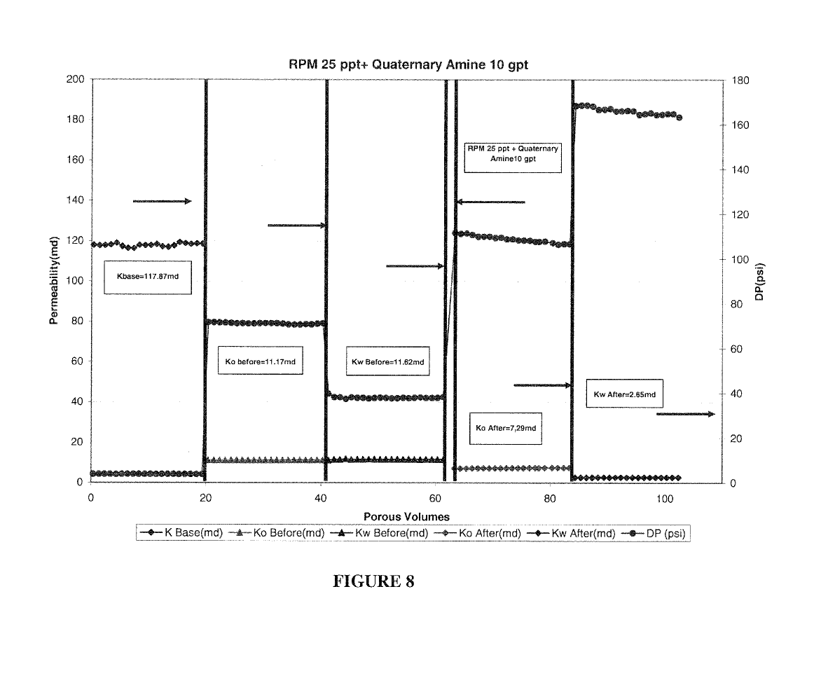

To determine the Disproportionate Permeability Reduction (DPR) effect of injecting RPM prepared in fresh water with a cationic quaternary amine clay stabilizer, static leak off tests were conducted on Berea sandstone core samples using the Sample 2 treatment fluid from Example 6 using those procedures described for Example 3. The results are presented in FIG. 8. The reduction in permeability of the core samples to water was 77% while the reduction in permeability to oil was 34%. The 77% reduction in the permeability to water of the treated core is greater than that obtained when treating a Berea core with a fluid system comprised of 0.3% by weight of treating fluid RPM and 2% by weight of treating fluid KCl, as in Example 8.

### Example 8

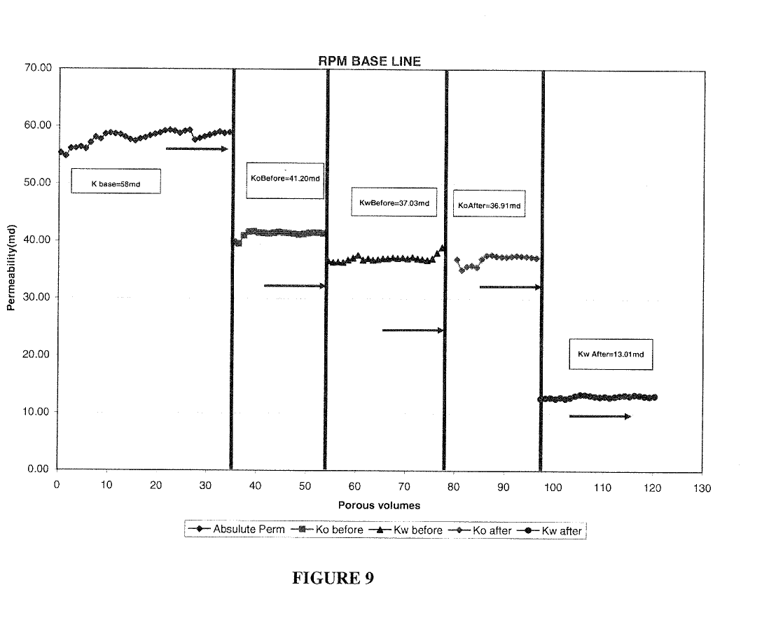

As a baseline in determining the DPR, a treatment fluid containing 0.3% by weight (25 ppt) RPM-A and 2 wt % KCl was prepared and used to treat Berea core samples using the same procedures of Example 3. The results are presented FIG. 9. The reduction in permeability of the core sample to water was 65% while the reduction in permeability to oil was 10%. The reduction in permeability of the treated core samples to water is similar to Example 7

### Example 9

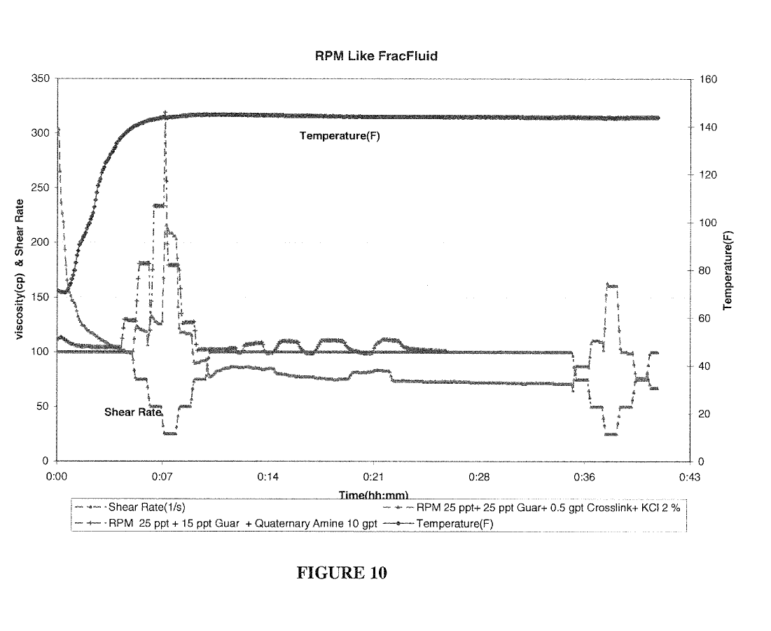

Aqueous treatment fluids containing linear and crosslinked guar were prepared to determine their viscosities. The linear fluid used fresh water and contained 0.3% by weight of treating fluid (25 ppt) RPM-A, 0.15% by weight of treating fluid (15 ppt) Guar-A and 10 gpt Amine Salt A. The crosslinked fluid contained 0.3% by weight of treating fluid (25 ppt) RPM-A, 0.3% by weight of treating fluid (25 ppt) Guar-A, 0.05% (0.5 gpt) triethanolamine titanate crosslinking agent and 2 wt % KCl. The crosslinked fluid had a pH of 4.3 The viscosities were measured using a Chandler 5550 Rheometer R1/B1. The results are presented in FIG. 10.

### Example 10

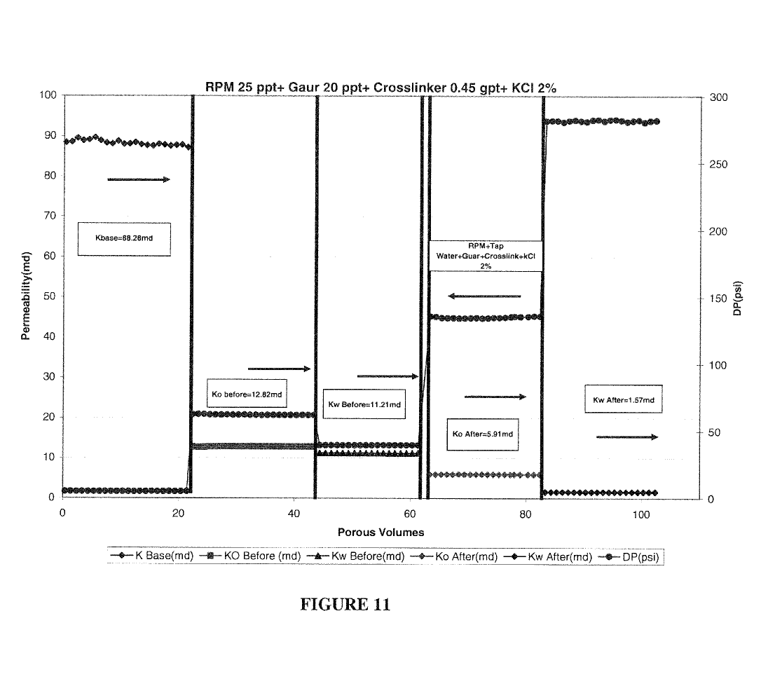

An aqueous treatment fluid containing crosslinked guar was prepared with 0.3% by weight of treating fluid (25 ppt) RPM-A, 0.2% by weight of treating fluid (20 ppt) Guar-A, 0.045% by weight (0.45 gpt) triethanolamine titanate crosslinking agent and 2 wt % KCl. The crosslinked fluid had a pH of 4.3. The fluid was used to treat Berea core samples using the procedures described in Example 3. The results are presented in FIG. 11 and in Table 3 below. The reduction in permeability of the core sample to water after treatment was 85% while the reduction in permeability to oil was 53%. The 85% reduction in the permeability to water after the treatment was even greater than 65% reduction when treating a Berea core using the same concentration (0.3% by weight of treating fluid) of the RPM in a 2% KCl brine.

TABLE 3

| | Before | After |
|---|---|---|
| Swr | 38% | 43% |
| Kro a Swr | 0.12 | 0.09 |
| Sor | 40% | 29% |
| Krw a Sor | 0.61 | 0.28 |

### Example 11

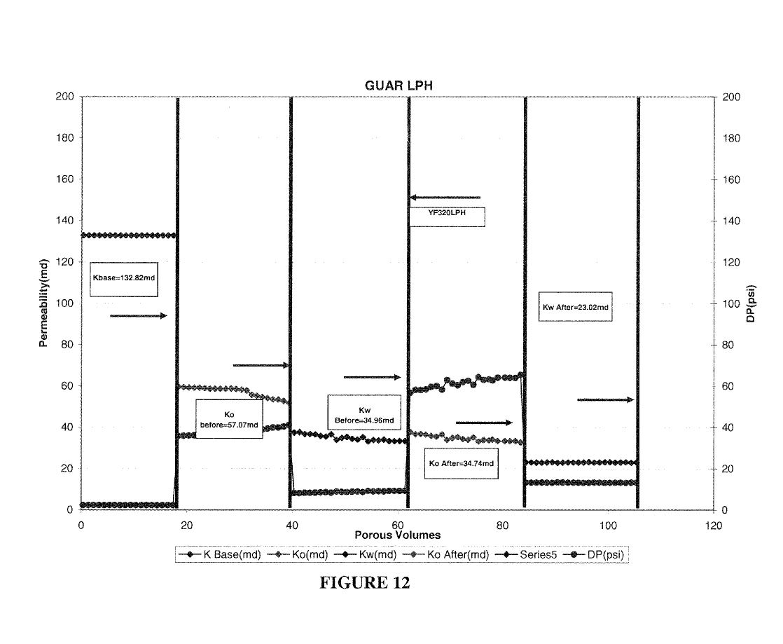

As a comparison, a low pH triethanolamine titanate crosslinked guar solution was prepared without the use of RPM and was used in treating Berea core samples using the procedures of Example 3. The results are presented in FIG. 12. The permeability of the core samples to water decreased 32% while the permeability to oil decreased 43%. The higher drop in the permeability to oil is most likely due to polymer loading and thus more damage (plugging) to the matrix.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. A method for treating a subterranean formation penetrated by a wellbore, the method comprising:
forming at least one of a treatment fluid A and a treatment fluid B, wherein:
the treatment fluid A comprises an aqueous carrier fluid, a first relative permeability modifier (RPM) polymer, a water-soluble viscosifying polymer and a crosslinking agent capable of crosslinking the viscosifying polymer at a pH of from about 3 to about 5; and
the treatment fluid B comprises a fresh-water carrier fluid and a second relative permeability modifier (RPM) polymer; and
introducing at least one of the treatment fluids A and B into the formation through the wellbore.

2. The method of claim 1, wherein:
the relative permeability modifier (RPM) is a hydrophilic, cationic substituted polyacrylamide polymer.

3. The method of claim 2, wherein:
the relative permeability modifier (RPM) has an average molecular weight of at least about 100,000.

4. The method of claim 1, wherein:
the RPM is present in the treatment fluids A and B in an amount of from about 0.01% to about 1% by weight of the treatment fluid.

5. The method of claim 1, wherein:
the crosslinking agent is a transition metal chelate crosslinking agent.

6. The method of claim 1, wherein:
the treatment fluid A further comprises a crosslinking delaying agent.

7. The method of claim 1, wherein:
the treatment fluid B further comprises a quaternary amine salt.

8. The method of claim 1, wherein:
at least one of the treatment fluids A and B further comprises an amount of fibers.

9. The method of claim 1, wherein:
the treatment fluid B further comprises an amount of fibers and a water-soluble viscosifying polymer.

10. The method of claim 1, wherein:
the at least one of the treatment fluids A and B are introduced into the formation through the wellbore at a pressure above the fracture pressure of the formation.

11. The method of claim 1, wherein:
the treatment fluid B further comprises a water-soluble viscosifying polymer.

12. A method for treating a subterranean formation penetrated by a wellbore, the method comprising:
forming a treatment comprised of an aqueous carrier fluid, a relative permeability modifier (RPM) polymer, a water-soluble viscosifying polymer and a crosslinking agent capable of crosslinking the viscosifying polymer at a pH of from about 3 to about 5; and
introducing the treatment fluid into the formation through the wellbore.

13. The method of claim 12, wherein:
the relative permeability modifier (RPM) is a hydrophilic, cationic substituted polyacrylamide polymer and has an average molecular weight of at least about 100,000.

14. The method of claim 12, wherein:
the RPM is present in the treatment fluid in an amount of from about 0.01% to about 1% by weight of the treatment fluid.

15. The method of claim 12, wherein:
the crosslinking agent is a transition metal chelate crosslinking agent.

16. The method of claim 12, wherein:
the treatment fluid further comprises a salt or electrolyte capable of suppressing hydration the RPM in the aqueous carrier fluid.

17. The method of claim 12, wherein:
the treatment fluid further comprises an amount of fibers.

18. A method for treating a subterranean formation penetrated by a wellbore, the method comprising:
forming a treatment fluid comprising a fresh-water carrier fluid and a relative permeability modifier (RPM) polymer; and
introducing the treatment fluid into the formation through the wellbore.

19. The method of claim 18, wherein:
the treatment fluid further comprises proppant and an amount of fibers to facilitate preventing the proppant from settling in the treatment fluid

20. The method of claim 18, wherein:
the treatment fluid further comprises a quaternary amine salt.

21. The method of claim 18, wherein:
the relative permeability modifier (RPM) is a hydrophilic, cationic substituted polyacrylamide polymer and has an average molecular weight of at least about 100,000.

22. The method of claim 18, wherein:
the RPM is present in the treatment fluid in an amount of from about 0.01% to about 1% by weight of the treatment fluid.

23. The method of claim 18, wherein:
the treatment fluid further comprises a water-soluble viscosifying polymer.
